(19) United States
(12) Patent Application Publication
(10) Pub. No.: US 2006/0082913 A1
(43) Pub. Date: Apr. 20, 2006

(54) Patterned master carrier for magnetic transfer, magnetic recording medium, and magnetic recording/reproducing apparatus

(75) Inventors: Kazuhiro Niitsuma, Odawara-shi (JP); Makoto Nagao, Odawara-shi (JP); Tadashi Yasunaga, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/251,839

(22) Filed: Oct. 18, 2005

(30) Foreign Application Priority Data
Oct. 18, 2004 (JP) 302682/2004

(51) Int. Cl. G11B 5/09; G11B 5/86; G11B 5/596

(52) U.S. Cl. 360/48; 360/77.08; 360/16

(57) ABSTRACT

Magnetic field absorbing regions, composed of protrusions or magnetic layers, are provided in an amplitude servo transfer pattern of a patterned master carrier for magnetic transfer. The magnetic field absorbing regions are provided in intermediate tracks between burst bit elements that constitute burst bit strings, which are provided adjacent to each other in a track width direction. The amplitude servo transfer pattern in magnetically transferred onto a magnetic recording medium. Portions of the magnetic recording medium corresponding to the magnetic field absorbing regions become magnetically non-inverted regions. Therefore, noise is not recorded, and servo tracking can be favorably performed.

### BACKGROUND OF THE INVENTION

1. Field of the Invention

The present invention relates to a patterned master carrier for magnetic transfer, employed for magnetically transferring magnetic bit patterns corresponding to servo signals of the reproduction amplitude type. The present invention also relates to a magnetic recording medium, on which an amplitude servo magnetic pattern is recorded by employing the patterned master. Further, the present invention relates to a magnetic recording/reproducing apparatus that houses the magnetic recording medium.

2. Description of the Related Art

Accompanying increases in amounts of data, magnetic recording media, which have high capacity, are inexpensive, and preferably enable readout of necessary portions in a short time, that is, capable of so-called high speed access, are desired. Various types of high density magnetic recording media are known. The data recording regions of the high density magnetic recording media are constituted by narrow tracks. Tracking servo technology plays a large role in enabling magnetic heads to scan the narrow tracks to reproduce signals with high S/N ratios. A sector servo technique is commonly employed to perform tracking servo.

The sector servo technique is a technique for causing magnetic heads to correct their positions. In the sector servo technique, servo data, such as servo signals, track address data signals, and reproduction clock signals, are recorded in servo fields. The servo fields are provided regularly at predetermined angles on data surfaces of magnetic recording media, such as magnetic disk media. Magnetic heads scan the servo fields and read out the servo data, to confirm and correct their positions.

A technique that employs reproduction amplitude data of servo signals is commonly applied to servo signals for track positioning. A common servo pattern comprises servo signals in A, B, C, and D burst portions. Each bit of A burst bit strings and B burst bit strings that constitute the A burst portion and the B burst portion is recorded at positions shifted one half of a track width from the center line of a track. When a reproducing magnetic head passes the servo field, positioning servo is applied such that the reproduction signal amplitude of the A and B burst bit strings are the same.

It is necessary for servo data to be recorded on magnetic recording media as preformatting during production thereof. Presently, preformatting is performed by dedicated servo recording apparatuses. The servo recording apparatuses are equipped with magnetic heads having head widths of approximately 75% of a track pitch, for example. A disk is rotated in a state in which a magnetic head of a servo recording apparatus is in close proximity thereto, and servo signals are recorded by moving the magnetic head from the outer periphery to the inner periphery of the disk every ½ tracks. Therefore, a long amount of time is required to preformat a single disk, which is a problem from the viewpoint or production efficiency.

Meanwhile, a method for accurately and efficiently preformatting magnetic recording media has been proposed in Japanese Unexamined Patent Publication Nos. 10(1998)-040544 and 10(1998)-269566. This method transfers patterns, which are formed on master carriers and bear servo data, to magnetic recording media by magnetic transfer.

Magnetic transfer employs patterned master carriers, which have transfer patterns constituted by uneven patterns that correspond to data to be transferred, to magnetic recording media (magnetic recording media), such as magnetic disk media. The master carriers and magnetic recording media are placed in close contact, then transfer magnetic fields are applied thereto. Thereby, magnetic patterns that correspond to data (servo signals, for example) borne by the uneven patterns of the master carriers are magnetically transferred to the magnetic recording media. Magnetic transfer is advantageous in that: recording can be performed statically, without changing the relative positions of the master carriers and the magnetic recording media; accurate preformatting is enabled; and the amount of time required for recording is extremely short.

As disclosed in Japanese Unexamined Patent Publication Nos. 10 (1998)-040544 and 10(1998)-269566, the amplitude servo patterns, which are employed as servo signals to position magnetic heads, include servo burst signals. The servo burst signals are constituted by burst bit strings, which are provided adjacent to each other along track width direction in different tracks, with intervals of approximately one track therebetween. A no-signal region of approximately one track width is present between burst bit strings, which are provided in different tracks. Particularly in the case that the servo patterns are recorded by magnetic transfer, there is a problem that magnetization is performed within the no-signal regions. The magnetization within the no-signal regions becomes a contributing factor of noise.

That is, when recording signal patterns of the aforementioned servo burst signals by magnetic transfer, there is no transfer pattern between the bit string signals provided adjacent to each other along the track width direction. Therefore, magnetic inversion is insufficient, causing subpeaks and the like to be generated with greater frequency. Unclear and unnecessary magnetization is performed at regions which are supposed to have no signals thereat, and as a result, a great amount of noise is generated.

In addition, in the aforementioned signal pattern, bit element strings are provided adjacent to each other along the track width direction, in different tracks. Therefore, when an external magnetic field is applied to perform magnetic transfer, magnetic fields that leak from bit elements are generated in the tracks between the bit element strings. These magnetic fields are transferred and recorded onto magnetic recording media, and also become contributing factors of noise.

Presently, narrowing of track widths is being contemplated, in order to increase the recording capacities of magnetic disk media. For example, there are magnetic disk media about to be realized, having track pitches of approximately 200 nm. Because the reproduction amplitude of each burst bit string becomes smaller due to the decrease in track pitch, there is a possibility that the accuracy of positioning by tracking will deteriorate, due to the aforementioned noise.

### SUMMARY OF THE INVENTION

The present invention has been developed in view of the foregoing circumstances. It is an object of the present invention to provide a patterned master carrier for magnetic transfer, which is capable of favorably recording a magnetic amplitude servo pattern of the reproduction amplitude type onto magnetic recording media by magnetic transfer, without generating noise. It is another object of the present invention to provide a magnetic recording medium, on which the magnetic amplitude servo pattern is recorded by the patterned master carrier for magnetic transfer. It is a further object of the present invention to provide a magnetic recording/reproducing apparatus that employs the magnetic recording medium.

The patterned master carrier for magnetic transfer of the present invention comprises:

a surface; and

an amplitude servo transfer pattern formed on the surface; the amplitude servo transfer pattern comprising:

servo burst signals, constituted by burst bit strings which are provided adjacent to each other in a track width direction; and

protrusions or a magnetic layer for absorbing magnetic fields during magnetic transfer, provided in tracks between the servo burst strings.

It is desirable that the ratio of the length of each bit of the burst bit string in the track direction with respect to the length thereof in the track width direction is 2 or less.

It is preferable that the protrusions or the magnetic layer are not provided in data portions, which are continuously formed, of the amplitude servo pattern.

The magnetic recording medium of the present invention is a magnetic recording medium, on a magnetic recording layer of which a magnetic amplitude servo pattern is recorded by magnetic transfer, employing the patterned master carrier of the present invention.

The burst bits, which are magnetically transferred onto the magnetic recording medium, correspond to burst bit elements of the patterned master carrier on a one to one basis. Similarly, the burst bit strings of the magnetic recording medium correspond to element strings of the patterned master carrier.

A single burst bit or a plurality of burst bits may constitute the burst bit element strings of the amplitude servo pattern to be recorded onto the magnetic recording medium. In the case that the burst bit element strings are constituted by a plurality of burst bits, the recording lengths of each recording region are equal in the track width direction, and the end positions of the burst bits in the track width direction are matched. Similarly, a single burst bit element or a plurality of burst bit elements may constitute the burst bit element strings formed on the surface of the patterned master carrier. In the case that the burst bit element strings are constituted by a plurality of burst bit elements, the lengths of the upper surfaces thereof are equal in the track width direction, and the end positions of the burst bit elements in the track width direction are matched.

The magnetic recording/reproducing apparatus of the present invention comprises:

a magnetic head;

a preformatted magnetic recording medium, provided so as to face the magnetic head;

drive means for driving the magnetic head;

drive means for driving the magnetic recording medium; and

recording/reproducing signal processing means for transmitting and receiving signals to and from the magnetic head and for processing the signals;

the magnetic recording medium being preformatted by employing the patterned master carrier of the present invention.

Note that here, the “preformatted magnetic recording medium” is provided at a position at which the magnetic head is capable of reading and writing therefrom and thereto. At times other than recording or reproducing, the magnetic recording medium may be fixed at the aforementioned position, or may be in a removable state therefrom.

The patterned master carrier for magnetic transfer of the present invention comprises the amplitude servo transfer pattern formed on the surface thereof. The amplitude servo transfer pattern comprises: the servo burst signals, constituted by the burst bit strings which are provided adjacent to each other in the track width direction; and the protrusions or the magnetic layer for absorbing magnetic fields during magnetic transfer, provided in tracks between the servo burst strings. Accordingly, when a transfer magnetic field is applied to perform magnetic transfer onto a magnetic recording medium, the magnetic field is absorbed by the protrusions or the magnetic layer. Therefore, leakage of the magnetic field to no-signal regions between the servo burst signals, which are provided adjacent to each other in the track width direction, is reduced. Thereby, magnetic inversion does not occur at the no-signal regions of tracks between the burst strings, and magnetic transfer can be executed with little noise.

In the magnetic recording medium of the present invention, noise caused by leakage of magnetic fields is not recorded in tracks between servo burst signals, which are provided adjacent to each other in the track direction. Therefore, the magnetic recording medium enables accurate tracking based on detection of burst signals.

In the case that of conventional magnetic recording medium having narrow track widths on the order of 200 nm or less, reduction of reproduction output from burst bits and deterioration of S/N ratios had been problems. However, in the magnetic recording medium of the present invention, the ratio of noise can be suppressed even if the reproduction output is reduced, and positioning servo, based on reproduction signals of the amplitude servo pattern, can be easily controlled.

In the case that the length in the track direction of the burst bits, which are recorded onto disks, differs at the inner circumferential portion and the outer circumferential portion, there is a tendency that noise increases between the longer outer circumferential portion and the burst bit string adjacent thereto. However, conspicuous noise reduction effects, due to formation of the protrusions or the magnetic layer, can be obtained at regions in which the ratio of the length of each bit of the burst bit string in the track direction with respect to the length thereof in the track width direction is set to be 2 or less.

The magnetic recording/reproducing apparatus of the present invention is capable of realizing highly accurate tracking servo, without erroneous detection of the servo signals recorded on the magnetic recording medium.

### BRIEF DESCRIPTION OF THE DRAWINGS

FIGS. 1A, 1B, and 1C illustrate a patterned master carrier for magnetic transfer according to an embodiment of the present invention, wherein FIG. 1A is a plan view, FIG. 1B is a magnified view of a portion of a transfer pattern, and FIG. 1C is a sectional view of a portion of the patterned master carrier.

FIGS. 2A, 2B, and 2C are diagrams for explaining the basic steps of magnetic transfer.

FIG. 3 is a magnified view that illustrates a portion of a magnetic pattern of servo signals, which are recorded on a recording/reproducing layer of a magnetic recording medium of the present invention.

### DESCRIPTION OF THE PREFERRED EMBODIMENTS

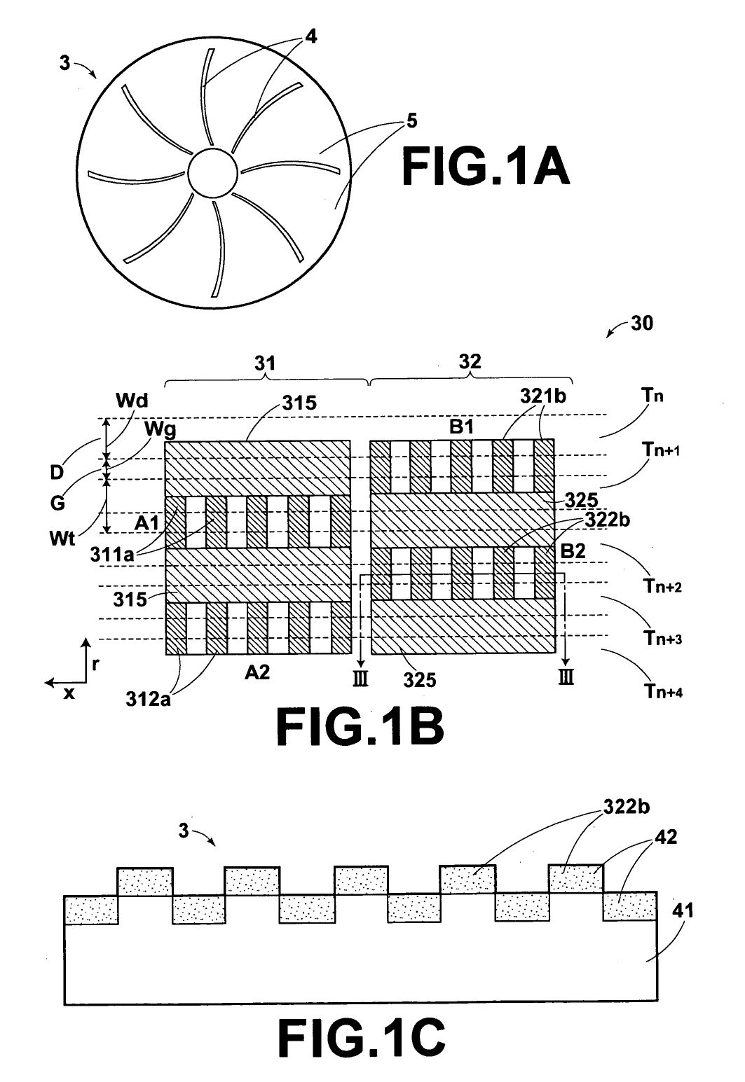

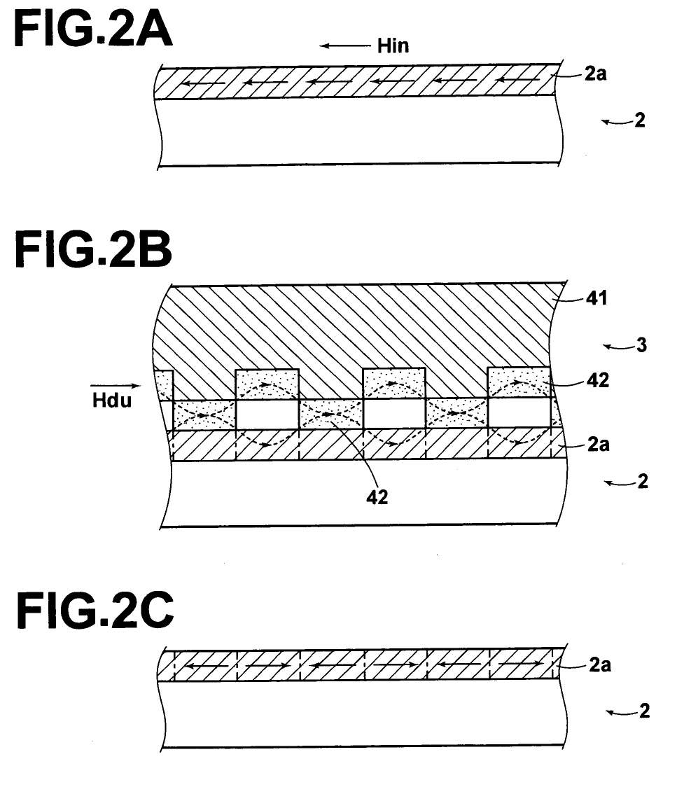

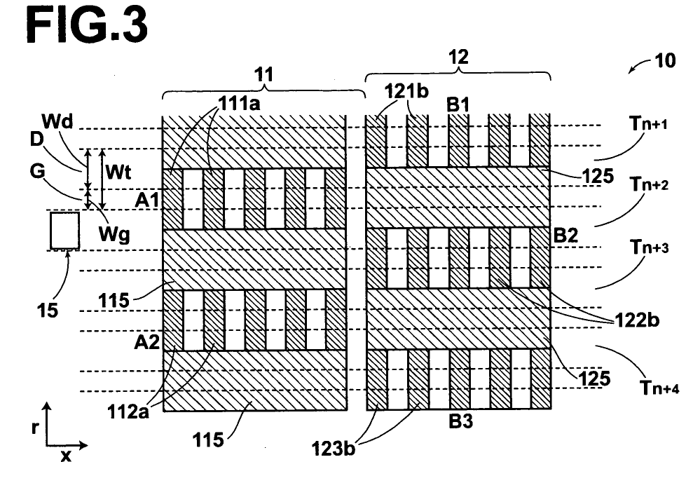

Hereinafter, a preferred embodiment of the present invention will be described in detail, with reference to the attached drawings. FIGS. 1A, 1B, and 1C illustrate a patterned master carrier 3 for magnetic transfer according to an embodiment of the present invention, wherein FIG. 1A is a plan view, FIG. 1B is a magnified view of a portion of a transfer pattern, and FIG. 1C is a sectional view of a portion of the patterned master carrier 3. FIGS. 2A, 2B, and 2C are diagrams for explaining the basic steps of magnetic transfer. FIG. 3 is a magnified view that illustrates a portion of a magnetic pattern of servo signals, which are recorded on a recording/reproducing layer 2a of a magnetic recording medium 2 of the present invention.

Before describing the patterned master carrier 3 of the present invention with reference to FIG. 1, an example of a magnetic amplitude servo pattern 10, which is recorded onto the magnetic recording medium 2 by magnetic transfer (refer to FIGS. 2A, 2B, and 2C), will be described with reference to FIG. 3.

The magnetic amplitude servo pattern 10 is recorded on the recording/reproducing layer 2a of the magnetic recording medium 2. The magnetic recording medium 2 is a discoid magnetic recording medium, such as a high density flexible disk or a hard disk, and comprises a substrate and the recording/reproducing layer 2a, constituted by a magnetic layer, provided on one or both sides of the substrate. Note that a thin coated magnetic layer or a metallic thin film magnetic layer is favorable as the recording/reproduction layer, in order to achieve high density recording. The substrate may be either flexible or hard.

Concentric or spiral tracks Tn are formed on the recording/reproduction layer 2a of the magnetic recording medium 2. In the present embodiment, a magnetic pattern that corresponds to the magnetic amplitude servo pattern 10 is recorded on the tracks Tn. Servo signals are recorded within servo fields, which are formed in thin regions that extend substantially radially outward at equidistant intervals from the center of the disk. The servo signals are employed in servo tracking of a head during reproduction. The magnetic amplitude servo pattern 10 may be visually confirmed by means of magnetic development, as necessary.

As illustrated in FIG. 3, data tracks D and guard bands G are formed sequentially adjacent to each other along a track width direction r on the magnetic recording medium 2, to form the tracks Tn. Note that a width Wt, which is the sum of a width Wd of each data track D and a width Wg of each guard band G, corresponds to a track pitch. Here, the track pitch Wt is set to be approximately 200 nm or less. A reproduction head 15 is illustrated in FIG. 1 as a reference. The reproduction head 15 is positioned by the servo signals so that it passes through the data tracks D. The length of the reproduction head 15 in the track width direction r is generally shorter than the data track width Wd. In FIG. 1, arrow x indicates the track direction, and arrow r indicates the track width direction. Note that the arrow r coincides with the radial direction of the disk.

The magnetic amplitude servo pattern 10 is constituted by servo signals comprising A, B, C, and D bursts for positional control, which are recorded in this order in the track direction x. FIG. 3 illustrates the portion of the magnetic pattern 10, at which A burst bit strings 11 and B burst bit strings 12 are recorded, among tracks Tn+1 through Tn+4. Pluralities of aligned rectangular A burst bits 111a and 112a constitute the A burst bit strings 11, and pluralities of aligned rectangular B burst bits 121b, 122b, and 123b constitute the B burst bits strings 12. Note that in the magnetic pattern recorded on the magnetic recording medium 2, the hatched portions are magnetic non-inverting regions (regions at where magnetic inversion does not occur) during magnetic transfer. The hatched portions and the non-hatched portions (blank portions) are magnetized at opposite polarities. The ratio between the lengths of each of the burst bits (hatched portions) and the non-hatched portions to the next burst bit, in the track direction, is 1:1. Each of the hatched portions and the non-hatched portions correspond to a single bit. Accordingly, two bits are included within a phase of 360°.

The recording regions of the A burst bit strings 11 and the B burst bit strings 12 are provided from the approximate center of a data track D to the approximate center of an adjacent data track D, so as to straddle the two data tracks D. The A burst bit strings 11 and the B burst bit strings 12 are alternately recorded along the track width direction r. C burst bit strings and D burst bit strings that constitute the C burst and the D burst signals (not shown) are constituted by burst bits similar to those of the A and B burst bit strings. The recording regions of the C burst bit strings and the D burst bit strings are respectively provided on odd and even tracks. In addition, the recording regions are provided from the approximate center of a track to the approximate center of an adjacent track, such that they straddle the two tracks and have widths of approximately a single track pitch Wt.

Each of the pluralities of burst bits that constitute each of the burst bit strings of the magnetic amplitude servo pattern (for example, the five burst bits 111a illustrated in FIG. 3 that constitute the A1 burst bit string that straddles track Tn+1 and Tn+2) have equal recording lengths in the track width direction r, and the positions of the ends thereof, in the track width direction r, are matched.

The A1 burst bit string and the B2 burst bit string illustrated in FIG. 3 are employed to position the head 15 on the second track Tn+2. The A1 burst bit string straddles the first track Tn+1 and the second track Tn+2. The B2 burst bit string straddles the second track Tn+2 and the third track Tn+3. The A burst bits 11a, which are recorded straddling the first track Tn+1 and the second track Tn+2, are also employed to position the head 15 along the first track Tn+1. Meanwhile, the B burst bits 12a, which are recorded straddling the second track Tn+2 and the third track Tn+3, are also employed to position the head 15 along the third track Tn+3.

Positioning servo is applied to the head 15 so that reproduction amplitudes A and B, of the A burst bit row 11 and the B burst bit row 12 respectively, become equal, and the magnetic head 15 is positioned along the second track Tn+2.

In the magnetic amplitude servo pattern 10, the A1 burst bit string, which is recorded such that it straddles the first track Tn+1 and the second track Tn+2, and the A2 burst bit string, which is recorded such that it straddles the third track Tn+3 and the fourth track Tn+4, are recorded adjacent to each other along the track width direction r with a no-signal region (hereinafter, referred to as “intermediate track”) of approximately one track width Wt therebetween. The entire intermediate track is formed as a non-inverting region 115. Similarly, the entire intermediate track between the B1 burst bit string and the B2 burst bit string, and the entire intermediate track between the B2 burst bit string and the B3 burst bit string are also formed as non-inverting regions 125.

In this manner, non-inverting regions 115 and 125 are provided between each pair of the A, B, C, and D burst bit strings which are adjacent in the track width direction r, in the magnetic amplitude servo pattern 10. In the case that no-signal regions are formed by magnetic inversion, unclear magnetic inversion patterns are generated by leakage of magnetic fields from bit elements at both sides thereof. However, by forming these regions as regions that are not magnetically inverted, the generation of noise due to unclear magnetic inversion patterns, caused by the leakage of magnetic fields from the bit elements at both sides thereof, can be prevented. Accordingly, when the head 15 scans these portions, the non-inverting regions function as no-signal regions without noise. Therefore, noise is not detected, and accurate tracking, based on detection of the burst signals, can be performed.

Note that intermediate tracks between the C burst bit strings and the D burst bit strings (not shown) may also be formed as non-inverting regions as described above.

Recording of the magnetic amplitude servo pattern 10 such as that described above onto the magnetic recording medium is performed by magnetic transfer, due to the shapes of the burst bits and the like.

Next, the method for producing the magnetic recording medium 2, by recording the magnetic amplitude servo pattern onto the magnetic recording medium 2 using magnetic transfer, will be described with reference to FIG. 1 and FIG. 2. The basic steps of the method is to place a surface of the patterned master carrier 3 and the recording/reproducing layer 2a of the magnetic recording medium 2 in close contact; and applying a magnetic field to the patterned master carrier 3 and the magnetic recording medium 2, which are in close contact; thereby magnetically transferring a magnetic amplitude servo transfer pattern 30 from the patterned master carrier 3 to the magnetic recording medium 2. The magnetic amplitude servo transfer pattern 30 of the patterned master carrier 3 comprises: servo burst signals, which are provided on different adjacent tracks; and protrusions or a magnetic layer, for absorbing magnetic fields such that magnetic inversion does not occur, provided in intermediate tracks between the servo burst signals.

The patterned master carrier for magnetic transfer 3 is illustrated in FIGS. 1A, 1B, and 1C. FIG. 1A is a plan view of the patterned master carrier 3, FIG. 1B is a magnified view of a portion of FIG. 1A, and FIG. 1C is a sectional view taken along line III-III of FIG. 1B.

As illustrated in FIG. 1A, the patterned master carrier 3 is discoid in shape, and has servo fields 4 formed in thin regions that extend substantially radially outward at equidistant intervals from the center thereof. The amplitude servo transfer pattern 30, formed by protrusions and recesses that correspond to servo signals, is formed in the servo fields 4. The regions denoted by reference numeral 5, formed among the servo fields 4 of each track, are data regions. The data regions 5 are for users to record and reproduce desired data thereto and therefrom. Generally, nothing is recorded in the data regions 5 by magnetic transfer.

FIG. 1B is a partial magnified view of A element strings and B element strings within the amplitude servo transfer pattern 30 within a servo field 4 that correspond to the A burst bit strings and the B burst bit strings of FIG. 3. A pattern constituted by protrusions and recesses are formed along tracks on the surface of the patterned master carrier 3, which are equivalent to the tracks of the magnetic recording medium 2. Tracks Tn, data tracks D and guard bands G of the patterned master carrier 3 and the widths thereof that correspond to those of FIG. 3 are denoted with the same reference symbols.

The hatched portions in FIG. 1B are protrusions that have magnetic layers 42 on their surfaces to absorb magnetic fields during magnetic transfer, as will be described later. The non-hatched blank portions are recesses, or regions at which magnetic layers are not provided. During magnetic transfer, magnetic inversion occurs in the recording/reproducing layer 2a at portions that correspond to the blank portions, and does not occur at portions that correspond to the protrusions at the hatched portions.

The data regions 5 among the servo fields 4, in which the transfer pattern 30 is formed, are formed as recesses where magnetic inversion occurs, or as regions without magnetic layers, similar to the blank portions of FIG. 1B. By forming the data regions 5 on the surface of the patterned master carrier 3 as recesses or as regions without magnetic layers, air can be ejected during close contact with the magnetic recording medium 2, thereby improving close contact properties therewith. In addition, the production process of the patterned master carrier 3 is simplified, and is advantageous from the viewpoint of cost.

The amplitude servo transfer pattern 30 comprises protrusions, the upper surfaces of which are burst bit elements 311a and 312a that respectively correspond to the burst bit elements 111a of the A1 burst bit string and the burst bit elements 112a of the A2 burst bit string; and protrusions, the upper surfaces of which are burst bit elements 321b and 322b that respectively correspond to the burst bit elements 121b of the B1 burst bit string and the burst bit elements 122b of the B2 burst bit string. The A1 burst bit string is formed such that it straddles the first track Tn+1 and the second track Tn+2. The B2 burst bit string is formed such that it straddles the second track Tn+2 and the third track Tn+3.

In the amplitude servo transfer pattern 30, the A1 burst bit string, which is recorded such that it straddles the first track Tn+1 and the second track Tn+2, and the A2 burst bit string, which is recorded such that it straddles the second track Tn+2 and the third track Tn+3, are recorded adjacent to each other along the track width direction r with an interval of approximately one track width Wt therebetween. The one track wide interval (intermediate track) is formed as a protrusion 315 that absorbs magnetic fields during magnetic transfer, such that magnetic inversion does not occur. Similarly, the one track width Wt wide intermediate track between the elements 321b of the B1 burst bit string and the elements 322b of the B2 burst bit string is also formed as a protrusion 325 that absorbs magnetic fields during magnetic transfer, such that magnetic inversion does not occur.

As illustrated in the partial cross sectional view of FIG. 1C, the patterned master carrier 3 comprises: a substrate 41, on the surface of which the uneven pattern is formed; and a magnetic layer 42, which is formed on the substrate 41. In the present embodiment, protrusive portions 322b of the magnetic layer 42 constitute each of the elements 311a, 312a, 321b, and 322b of the A and B burst bit strings, as well as the protrusions 315 and 325.

The substrate 41 of the patterned master carrier 3 maybe formed, for instance, of nickel, silicon, a quartz plate, glass, aluminum, ceramics or synthetic resin. Nickel and alloys having nickel as their main components are preferable as materials of the substrate.

The magnetic material of the magnetic layer 42 may be Co, Co alloys (e.g., CoNi, CoNiZr and CoNbTaZr), Fe, Fe alloys (e.g., FeCo, FeCoNi, FeNiMo, FeAlSi, FeAl and FeTaN), Ni or Ni alloys (e.g., NiFe). FeCo and FeCoNi are preferable as the material of the magnetic layer 42. Fe70Co30 is particularly preferable as the material of the magnetic layer. Note that favorable transfer can be performed by employing a magnetic layer 42 having low magnetic coercive force, such as a soft magnetic material or a semi-rigid magnetic material. Further, it is preferable that the magnetic layer 42 has a higher saturation magnetization value than that of the substrate 41.

The uneven irregular pattern of the patterned master carrier 3 can be formed, for instance, by the use of stamper method or photolithography. As an example of a method for producing the patterned master carrier 3, first, a first original disk having an uneven pattern corresponding to a signal pattern (including those in which the protrusions and recesses of the uneven pattern are inverted) on its surface is produced. Then, a metal plate having the uneven pattern on its surface can be produced by employing the original disk to perform electrocasting.

The first original disk having the uneven pattern on its surface can be produced by employing a photolithography method or the like. Hereinafter, a case in which the original disk is produced using a silicon wafer will be described. However, a quartz plate or a glass plate may be utilized instead of the silicon wafer.

First, a positive type electron beam resist layer is coated on a discoid silicon wafer having a smooth surface by a spin coat method or the like. An electron beam, which is modulated according to the aforementioned signal pattern, is irradiated onto the resist layer while the silicon wafer is rotated. Thereby, the entire resist layer is irradiated with the electron beam, modulated according to the signal pattern. In the case that the signal pattern represents servo signals to be utilized by magnetic disks, for example, patterns corresponding to servo signals are irradiated on each of a great number (several tens of thousands, for example) of concentric tracks, which are formed with predetermined intervals therebetween. The patterns corresponding to servo signals extend in the circumferential direction, within each of a plurality (200, for example) of sectors, which are provided at predetermined intervals along each of the tracks. After the entire resist layer has been irradiated in this manner, a development process is administered to the resist, and the portions of the resist irradiated by the electron beam are removed from the silicon wafer. Thereby, a pattern, in which protrusions are constituted by resist and recesses are constituted by the portions at which the resist has been removed to expose the silicon wafer, is formed. That is, the silicon wafer becomes the first original disk.

Electrocasting is performed employing the first original disk, which is formed in this manner. That is, electroless plating of a metal, such as nickel or silver, is performed on the uneven surface of the first original disk, to form a thin conductive layer. Then, nickel is electroplated such that the nickel layer is sufficiently thicker than the height of the protrusions. Thereafter, by separating the electroplated nickel from the first original disk, a nickel plate (hereinafter, referred to as “first cast”) having an uneven pattern that corresponds to the servo signals on the surface thereof, in which the portions irradiated by the electron beam are protrusions, is obtained. The first cast obtained in this manner may be utilized as the patterned master carrier 3 as is. Alternatively, a soft magnetic layer and a protective layer may be provided on the uneven surface of the first cast, then the first cast may be utilized as the patterned master carrier 3.

Alternatively, the first cast may be employed as a second original disk, and further electroplating may be performed to produce a nickel plate (hereinafter, referred to as “second cast”) having an uneven pattern on the surface thereof. The second cast obtained in this manner may be utilized as the patterned master carrier 3 as is. Alternatively, a soft magnetic layer and a protective layer may be provided on the uneven surface of the second cast, then the second cast may be utilized as the patterned master carrier 3. In this case, it is preferable that either: (1) a negative type electron beam resist is utilized, and the electron beam is irradiated according to a signal pattern corresponding to the servo signals; or (2) the positive type electron beam resist is utilized, and the electron beam is irradiated according to a signal pattern according to an inverted servo pattern, during production of the first original disk. Use of the first cast as the second original disk is advantageous in that a plurality of patterned master carriers can be produced from the second original disk.

Alternatively, the second original disk may be utilized as a stamper, to mold a resin disk having an uneven surface with the stamper method. A soft magnetic layer and a protective layer may be provided on the uneven surface of the resin disk, then the resin disk may be utilized as the patterned master carrier 3.

Meanwhile, if the surface of the first original disk is subject to an etching process, the resist that forms the protrusions functions as an etching resist. Therefore, the surface of the silicon wafer can be selectively etched at the portions corresponding to the recesses. By removing the resist that forms the protrusions after performing the etching process, a third original disk, which is the silicon wafer having the uneven pattern on its surface, is obtained. By performing electroforming utilizing the third original disk in the same manner as that described above, a nickel plate (hereinafter, referred to as “third cast”) having an uneven pattern on the surface thereof can be produced. The third cast obtained in this manner may be utilized as the patterned master carrier 3 as is. Alternatively, a soft magnetic layer and a protective layer may be provided on the uneven surface of the third cast, then the third cast may be utilized as the patterned master carrier 3. In this case as well, a plurality of patterned master carriers 3 can be produced from the third original disk.

The height of the protrusions (the depth of the uneven pattern) of the patterned master carrier 3 is preferably within the range of 20 to 500 nm. More preferably, the height of the protrusions is within the range of 40 to 100 nm. In the case that the uneven pattern corresponds to servo signals, rectangular protrusions, which are longer in the radial direction than in the circumferential direction (track direction), are formed.

The soft magnetic layer is formed on the uneven pattern of the substrate 41 by: vacuum film forming methods, such as a vacuum vapor deposition method, a sputtering method, and an ion plating method; or plating methods, such as electroplating and electroless plating. The thickness of the soft magnetic layer (the thickness of the magnetic layer 42 on the upper surfaces of the protrusions) is preferably within the range of 20 to 500 nm, and more preferably within the range of 30 to 100 nm.

A protective layer of diamond like carbon (DLC) having a thickness of 3 to 30 nm may be provided on the magnetic layer 42 to improve the durability thereof. Further, a lubricant layer may be provided. A close contact enhancing layer formed of Si or the like may also be provided between the magnetic layer and the protective layer. The lubricating layer suppresses damage due to friction, when positional shifting is corrected during the contacting step between the patterned master carrier 3 and the magnetic recording medium 2, thereby further improving the durability of the patterned master carrier 3.

Note that the construction of the patterned master carrier 3 for magnetic transfer is not limited to that described in the above embodiment. Any construction may be adopted, as long as the master carrier bears servo signals as an uneven pattern. The master carrier may be constituted by: only a magnetic substrate having an uneven pattern on its surface; a substrate having an uneven pattern on its surface and a magnetic layer provided at least on the upper surfaces of the protrusions of the pattern; a nonmagnetic substrate having an uneven pattern on its surface and a magnetic layer embedded within the recesses of the pattern; a flat substrate and a magnetic layer having an uneven pattern on its surface; and the like. Note that in the case that the patterned master carrier is constituted by a nonmagnetic substrate having an uneven pattern on its surface and a magnetic layer embedded within the recesses of the pattern, the aforementioned bit elements are constituted by the magnetic layer embedded within the recesses.

The ratio of the length of each bit of the burst bit string in the track direction with respect to the length thereof in the track width direction r (aspect ratio) is 2 or less. In the case of an amplitude servo pattern, the length in the track direction of the burst signals differs at the inner circumferential portion and the outer circumferential portion. Therefore, the aspect ratio becomes smaller at the outer circumferential portions of the burst signals. Magnetic fields that leak from the burst bit elements having low aspect ratios become large arcs, and there is a tendency that noise increases at the low aspect ratio portions. Accordingly, the noise reduction effect is greatly exhibited at the regions in which elements having aspect ratios of 2 or less are formed. Thereby, servo functions can be secured by detection of reproduction signals.

Next, the method by which the aforementioned patterned master carrier 3 for magnetic transfer is employed to record the magnetic pattern onto the magnetic recording medium 2 will be described with reference to FIGS. 2A, 2B, and 2C.

FIGS. 2A, 2B, and 2C are diagrams for explaining the basic steps of magnetic transfer. FIG. 2A illustrates a step in which the magnetic recording medium is initially magnetized by unidirectionally applying a DC magnetic field thereto. FIG. 2B illustrates a step in which a magnetic field is applied in substantially the opposite direction from that of the DC initial magnetic field while the patterned master carrier 3 and the magnetic recording medium 2 are in close contact with each other. FIG. 2C illustrates the state of the magnetic recording surface of the magnetic recording medium 2 following magnetic transfer.

First, as illustrated in FIG. 2A, the magnetic recording medium 2 is initially magnetized in advance, by applying a DC initial magnetic field Hᵢₙ in one track direction. Then, as illustrated in FIG. 2B, the recording surface of the magnetic recording medium 2 is brought into close contact with the transfer pattern surface of the patterned master carrier 3, and a transfer magnetic field H_{du} is applied in the direction opposite to that of the initial DC magnetic field Hᵢₙ. At the locations where the magnetic recording medium 2 and the protrusions of the transfer pattern of the patterned master carrier 3 are in close contact, the transfer magnetic field H_{du} is absorbed by the protrusions of the magnetic layer 42 of the patterned master carrier 3. The magnetization of the magnetic recording medium 2 at the positions corresponding to the protrusions of the master carrier 3 is not inverted, whereas the magnetization at other positions is inverted by magnetic field leakage from the protrusions. As a result, as shown in FIG. 2C, a magnetic pattern corresponding to the uneven pattern of the patterned master carrier 3 is magnetically transferred and recorded onto a magnetic recording layer 2a of the magnetic recording medium.

Note that it is necessary for the intensities of the initial magnetic field and the transfer magnetic field to be determined, considering the magnetic coercive force of the magnetic layer of the magnetic recording medium 2, and the magnetic permeability ratio between the master carrier and the magnetic layer of the magnetic recording medium.

Although not illustrated, a magnetic recording/reproducing apparatus that employs the magnetic recording medium 2, which is preformatted with the magnetic amplitude servo pattern 10, comprises: a magnetic head; the preformatted magnetic recording medium 2, provided so as to face the magnetic head; drive means for driving the magnetic head; drive means for driving the magnetic recording medium; and recording/reproducing signal processing means for transmitting and receiving signals to and from the magnetic head and for processing the signals. The preformat of the magnetic recording medium is an amplitude servo pattern comprising: servo burst signals, constituted by burst bit strings which are provided adjacent to each other in a track width direction; and non-inverting regions, provided in intermediate tracks between the servo burst strings. Therefore, the amplitude of reproduction signals can be made great with little noise, and accordingly, accurate positioning servo can be realized.

What is claimed is:

1. A patterned master carrier for magnetic transfer, comprising:
a surface; and
an amplitude servo transfer pattern formed on the surface; the amplitude servo transfer pattern comprising:
servo burst signals, constituted by burst bit strings which are provided adjacent to each other in a track width direction; and
protrusions or a magnetic layer for absorbing magnetic fields during magnetic transfer, provided in tracks between the servo burst strings.

2. A patterned master carrier for magnetic transfer as defined in claim 1, wherein:
the ratio of the length of each bit of the burst bit string in the track direction with respect to the length thereof in the track width direction is 2 or less.

3. A patterned master carrier for magnetic transfer as defined in claim 1, wherein:
the protrusions or the magnetic layer are not provided in data portions, which are continuously formed, of the amplitude servo pattern.

4. A patterned master carrier for magnetic transfer as defined in claim 2, wherein:
the protrusions or the magnetic layer are not provided in data portions, which are continuously formed, of the amplitude servo pattern.

5. A magnetic recording medium comprising:
a magnetic recording layer; and
a magnetic amplitude servo pattern recorded on the magnetic recording layer by magnetic transfer, the amplitude servo pattern comprising:
servo burst signals, constituted by burst bit strings which are provided adjacent to each other in a track width direction; and
non-inverting regions, provided in tracks between the servo burst strings.

6. A magnetic recording/reproducing apparatus, comprising:
a magnetic head;
a preformatted magnetic recording medium, provided so as to face the magnetic head;
drive means for driving the magnetic head;
drive means for driving the magnetic recording medium; and
recording/reproducing signal processing means for transmitting and receiving signals to and from the magnetic head and for processing the signals;
the magnetic recording medium being preformatted by a magnetic amplitude servo pattern being recorded on a magnetic recording layer thereof by magnetic transfer, the amplitude servo pattern comprising:
servo burst signals, constituted by burst bit strings which are provided adjacent to each other in a track width direction; and
non-inverting regions, provided in tracks between the servo burst strings.
